(19) United States
(12) Patent Application Publication
(10) Pub. No.: US 2008/0041929 A1
(43) Pub. Date: Feb. 21, 2008

(54) RFID TAG-BASED E-MAIL ADDRESS AUTOGENERATOR

(76) Inventors: BRIAN D. BAUMAN, Austin, TX (US); Amanda J. Bauman, Austin, TX (US); Michael P. Carlson, Austin, TX (US); Herman Rodriguez, Austin, TX (US)

Correspondence Address: The Brevetto Law Group, PLLC, 107 S. West Street, #765, Alexandria, VA, 22314, US

(21) Appl. No.: 11/465,223

(22) Filed: Aug. 17, 2006

(51) Int. Cl. G06F 17/00; G08B 13/14

(52) U.S. Cl. 235/375; 340/572.1

(57) ABSTRACT

Methods 400 are provided for using RFIDs to aid in creating and documenting electronic e-mail communications. A communication device 101 capable of sending e-mail is configured with an RFID transmitter and detector, or RFID transceiver. When the device is in the presence of other devices, the user may choose to capture the e-mail addresses of the other device using the RFID detection capability. Each device has an RFID associated with an e-mail address. By detecting the other RFID devices, the user may automatically capture their associated e-mail addresses.

### BACKGROUND

1. Field

Embodiments of the invention relate generally to e-mail communications, and more specifically to methods and systems that use RFIDs in the generation of addresses for e-mail.

2. Background

Over the past fifteen years or so e-mail has become a widely accepted a form of communication. Most households and nearly all businesses regularly use e-mail to communicate, with billions of e-mail messages being sent each day. Today, when people share their contact information they often exchange e-mail addresses as well as telephone numbers. This is generally done by either exchanging business cards or else jotting down each others' contact information on a slip of paper. Both methods require the user to save the scraps of paper and manually enter the contact information into one's computer.

It becomes more burdensome to exchange e-mail addresses among a group of several people, for example, among the attendees of a business meeting. A common ritual of business meetings often occurs at the end of the meeting when everyone exchanges contact information, including their e-mail addresses. This is sometimes done in an ad hoc manner, with each person passing out their business card to all other attendees, and in turn receiving a pile of business cards back. Then, typically, each person ends up back at their office with a stack of business cards for which the contact information data must be entered into the e-mail application of their computer (e.g., Lotus Notes or Microsoft Outlook).

Using conventional systems it is difficult and time consuming to collect the contact information for groups of people, for example at a business meeting, so as to send an e-mail to each of the attendees during the meeting or shortly thereafter. The time it takes to accumulate the other attendees e-mail addresses detracts from the effective meeting time, in essence costing the company or individual time and money. What is needed is a more robust means of entering contact information, and in particular, e-mail addresses.

### SUMMARY

Embodiments disclosed herein address the above stated needs by providing systems, methods and computer products for entering contact data such as e-mail addresses or the like. In accordance with at least one embodiment, a user's email device sends an RFID interrogation signal, and in response receives an RFID signal which contains contact information including the e-mail address. The e-mail address data in the signal is reformatted into a format acceptable to an e-mail application program, such as vCard or other like format. The e-mail address is provided to the e-mail application program on the user's email device. In some embodiments the e-mail address may be provided to the e-mail application program by modifying a data file associated with the e-mail application program to include the e-mail address. In another embodiment the e-mail address may be provided to the e-mail application program by sending it as content in an incoming e-mail to the email device. In at least one embodiment the email device may display a list of all detected e-mail addresses, affording the user an opportunity to modify the list by either deleting detected e-mail addresses or adding other e-mail addresses which do not appear on the list. In some embodiments the RFID signal may contain information of a uniform resource locator (URL) where additional user information can be retrieved.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1A depicts an exemplary RFID device which may be used to implement the various embodiments;

FIG. 1B depicts an exemplary email device which may be used in conjunction with an RFID device;

FIG. 2 depicts an exemplary system for practicing at least one embodiment of the invention;

FIG. 3 depicts an exemplary method of setting up a communication device to operate according to various embodiments; and

FIG. 4 depicts an exemplary method of practicing various embodiments of the invention.

### DETAILED DESCRIPTION

The following description of the various exemplary embodiments is illustrative in nature and is not intended to limit the invention, its application, or uses. The various embodiments disclosed herein provide methods and systems for scanning a preset area of proximity for RFID tags, for example, by completing the “To:” field in an e-mail program with the e-mail addresses of all the people (with RFID Tags) present within the defined proximity of the sending machine.

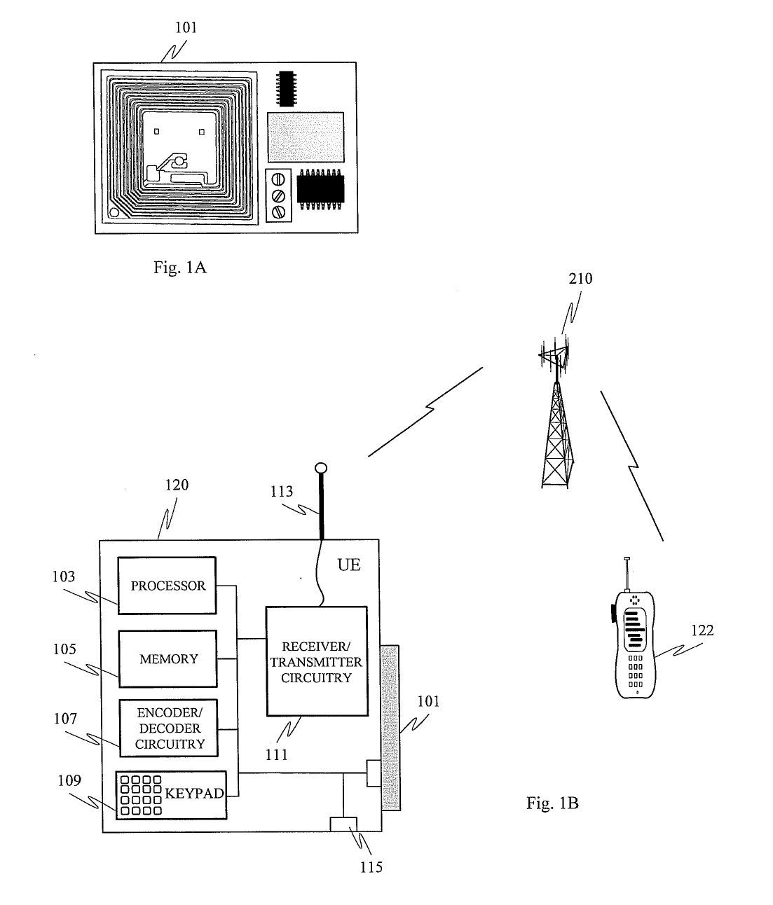

FIG. 1A depicts an exemplary RFID reader device 101 which may be used to implement the various embodiments. The RFID reader device 101 typically includes circuitry or logic capable of sending out an interrogation signal and receiving a response back, as well as circuitry or logic for responding to the interrogation signal of an RFID tag.

RFID tags are small devices that respond to an RF interrogation signal with a RF response at a predetermined frequency. The response may contain data in addition to identification information. RFID Tags may be implemented to either provide a passive response or an active response. Passive RFID tags use the received energy from the interrogation signal to generate a response. The detection range for passive RFID tags may be 15 to 20 feet.

Active RFID tags tend to have a considerably longer range than passive tags because they generate and transmit a response signal using power from a power supply of the active RFID tag (e.g., a battery). Active tags may be queried up to 200 feet or more. Various embodiments of the present invention may use either active RFID tags or passive RFID tags, depending upon the constraints, costs and other engineering considerations of the implementation.

An RFID reader typically includes circuitry configured to transmit an interrogation signal to other RFID tags in the vicinity. Upon receiving the interrogation signal, the other RFID tags in the vicinity return a response to the reader, either actively or passively, as described above. The RFID tags and RFID reader circuitry used to implement the invention may be any of several types of RFID tags and readers, including, for example, the RFID tags and readers described in U.S. Patent Publication 2005/0049760 to Narayanaswami et al., and in U.S. Pat. No. 6,802,659 to Cremon et al., the contents of both documents being hereby incorporated by reference in their respective entireties.

The RFID reader device 101 may be configured to include a silicon microprocessor and a metal coil surrounded by an encapsulating material of glass or polymer material. The metal coil, which serves as the tag's antenna, is typically made of copper or aluminum traces which are wound into a circular pattern on the tag. The size of the coil antenna determines the sensitivity of the RFID reader, and the distance the signals can be transmited. RFID coil antennas often operate at 13.56 MHz but can be designed to be operated at a wide range of other frequencies. In some embodiments, the RFID reader device 101 may be known as or configured as an RFID transceiver.

The RFID tag used in RFID reader device 101 may be an inductively coupled RFID tag which uses energy from the magnetic field generated by the RFID reader. The coil antenna of the RFID tag translates the magnetic energy into an electrical signal which is communicated to the logic of RFID reader device 101. To respond to the interrogation signal of another reader, the RFID tag of reader device 101 modulates the magnetic field, transmitting e-mail data back to the reader which sent the interrogation signal. The RFID tag used in RFID reader device 101 may be implemented as a capacitively coupled RFID as the detection and transmission ranges increase for these devices. Capacitively coupled RFID tend to cost less than inductively coupled RFID tags. Capacitively coupled RFID tags do not have a coil antenna, instead using silicon circuitry to perform the function of the coil antenna. A capacitively coupled RFID tag typically includes a silicon microprocessor and conductive carbon ink which serves as the tag's antenna applied to a paper substrate.

The conductive carbon ink antenna may be applied to the paper substrate through conventional printing means. The paper substrate, in turn, often has an adhesive backing to allow bonding to the email device 120-122.

The RFID reader device 101 may include a programmable memory configured to be modified or updated by an RFID writer. The RFID writer, which may be incorporated in the email device 120, can write to the programmable memory of the RFID reader device 101 to change data stored on it, for example, to change the user's email address stored on the RFID reader device 101. An RFID reader, which may be included as part of the RFID reader device 101, can feature bidirectional communication so as to be able to write to the programmable memory of the RFID reader device 101. In some embodiments, the user's email address can be written to the programmable memory by an RFID writer separate from the RFID reader device 101.

FIG. 1B depicts exemplary email devices 120-122 which may be used in conjunction with an RFID reader device 101. The email devices 120-122 are wireless devices configured to communicate via e-mail in a wireless communication system. Although the email devices 120-122 are depicted as cellular telephones, various embodiments may be practiced with the email device implemented as a laptop computer with communication capabilities, a push-to-talk (PTT) radio handset, a wireless pager, a text messaging device, a personal digital assistant (PDA) with communication capabilities, or any other such wireless communication device capable of conducting wireless e-mail communications. The email devices may also be embodied as fixed communication devices, including for example, LCD projectors, computers, or the like, used in conjunction with mobile RFID tag devices. The email devices 120-122 shown in the figure communicate via a wireless base station 210, which in turn, is connected to a wireless communication system. The wireless communication system may be a cellular telephone system, a paging system or other wireless system configured to carry on wireless communications with various embodiments of email devices 120-122. The wireless communications themselves may be digital or analog, and may be implemented using any of several encoding schemes or transmission technologies, e.g., FDMA, TDMA, CDMA, GSM, IP telephony through wi-fi, or a hybrid or these or other like schemes.

The email devices 120-122 are wirelessly coupled to the base station 210 of the wireless communication system via a wireless communication link. The establishment of a wireless communication link means that the email device 120-122 is registered with the wireless system for communication purposes. The base station 210 is typically connected to a mobile switching center (MSC) of the wireless communication system, which in turn, is connected to the public switched telephone network (PSTN). In some implementations of communication systems the landline portion of the communication link may pass through a portion of the Internet or another type of communications network. Other types and configurations of wireless communication systems known to those of ordinary skill in the art may be used to implement the various embodiments.

FIG. 1B shows some details of the email device 120. The email device 120 includes transmitter/receiver circuitry 111 configured to wirelessly send and receive signals to and from the base station 210. The email device 120 also includes RFID unit 101 configured to wirelessly send and receive RFID signals. The RFID reader unit 101 of email device 120 may be that depicted in FIG. 1A, or may be any other RFID reader capable of operating in conjunction the email device 120. The RFID reader unit 101 may include logic as well as memory, for example, a microprocessor often stores bits of information which may include the user's e-mail address. The RFID reader unit 101 may be incorporated into the email device 120, or may be externally attached and wired so that data is fed into a port or other input interface such as USB, FireWire or via an infrared or Bluetooth link, or any other like port or other input interface known to those or ordinary skill in the art. The memory 105 is configured to store the application program for practicing the various embodiments as well as the requisite logic and parameters to control the transmitter/receiver circuitry 111 and other functions of the email device 120. The memory 105 is typically integrated as part of the email device 120 circuitry, but may, in some embodiments, include or consist of a removable memory such as a removable disk memory, integrated circuit (IC) memory, a flash memory card, or the like. The memory 105 along with processor 103 typically stores and implements the settings, preferences and parameters for the RFID tag-based e-mail address autogenerator. The processor 103 and memory 105 may be configured to format e-mail messages, for example, for distribution to e-mail addresses detected from RFID signals.

The email device 120 may also have a microphone and speaker (not shown) for the user to speak and listen to callers or for entry and feedback of commands to the email device 120 (e.g., speech recognition). In addition the email device 120, when embodied as a mobile telephone, may include a ringer for alerting the user to incoming calls or messages including the detection of RFID tags in the vicinity. A keypad 109 is configured as part of email device 120 for received commands from a user, dialing telephone numbers, or otherwise entering data. Email devices 120 may be configured with a data input/output (I/O) port 115 for downloading data, programs and other information or connecting to a network or the Internet.

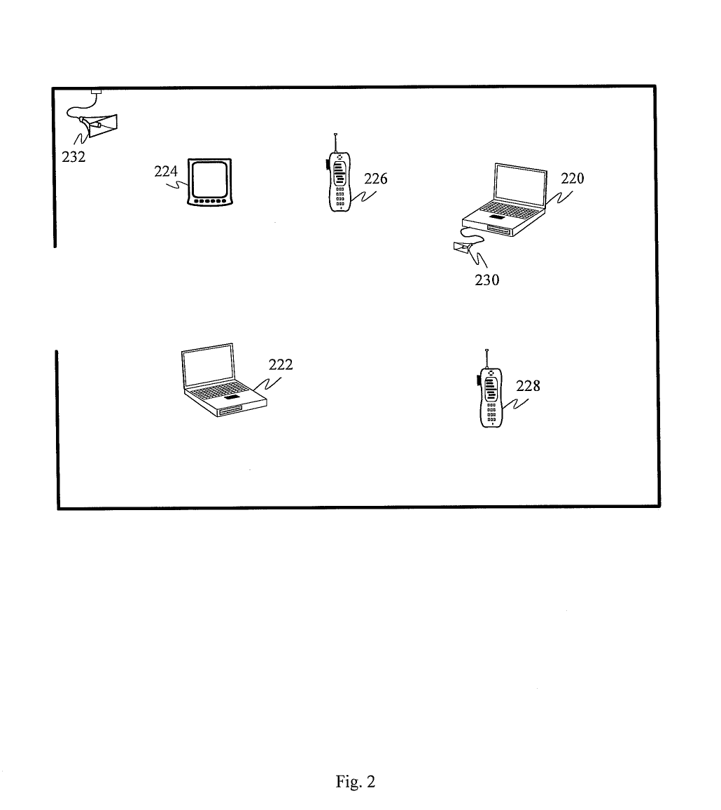

FIG. 2 depicts an exemplary system for practicing at least one embodiment of the invention. The email devices 220-228 of FIG. 2 are depicted within the confines of the effective area for the RF tag-based e-mail address autogenerator, in this case, an office, conference room or meeting room of the sort meetings generally take place in. If the walls are such that RFID signals do not pass through them, the boundaries of the e-mail address autogenerator area will be readily discernable. However, this is often not the case. The e-mail address autogenerator boundary which defines the area serviced by the call notification system. The local wireless transmitter/receiver circuitry is coupled to the access point, an RFID detector 232 of the call notification system, while the email device is within the call notification boundary. Any email devices not within the call notification boundary are not coupled to the access point 232 of the call notification system.

In some embodiments an RFID detector 232 wirelessly coupled (or wired) to the system, to the network, or to another conference room device such as a projector. In such embodiments the various email devices 220-228 communicate their e-mail address to the system RFID unit 232, and in turn, receive the e-mail address of the others present within the effective area (e.g., the room within which a meeting is taking place). If more than one system RFID detector 232 is in place (not shown), directional antennas may be used to detect RFIDs from a couple of directions, thus determining which RFIDs are within the conference room or other e-mail address autogenerator boundary. The various email devices 220-228 may be equipped with a directional receiving antenna, for example, such as antennal 230 coupled to email device 220. Some embodiments may have receiver circuitry capable of measuring the signal strength of a received RFID signal. Such embodiments may be set to only accept signals above a certain predefined signal strength level.

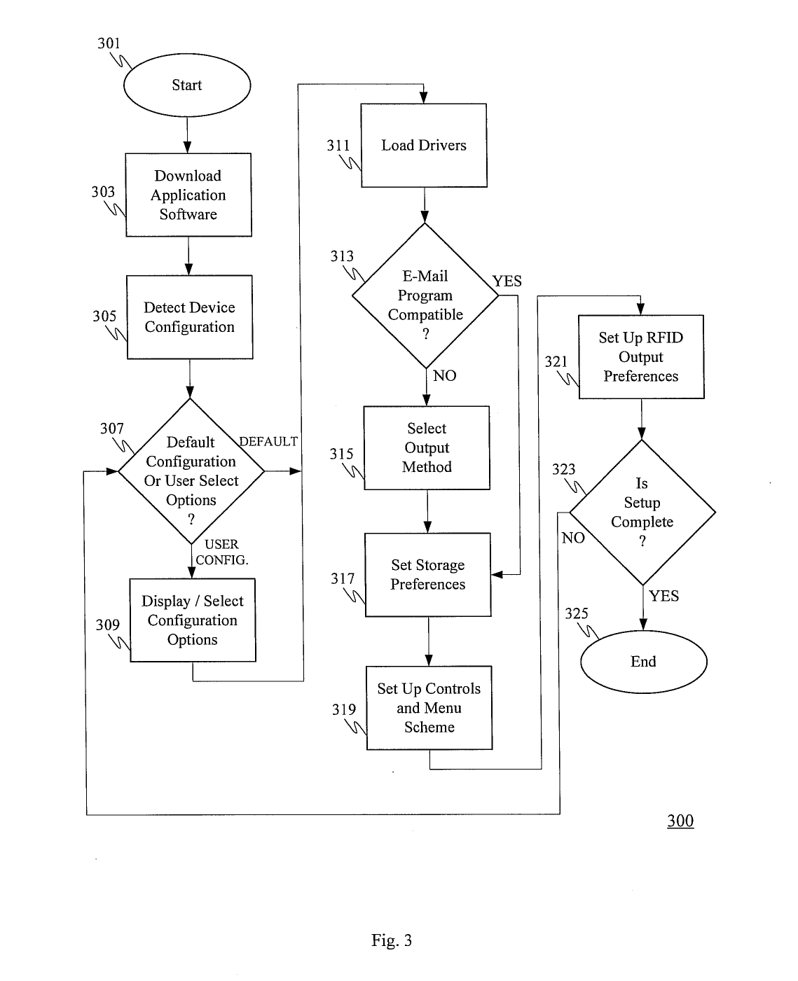

FIG. 3 depicts an exemplary method 300 of setting up a communication device to operate according to various embodiments. The method of FIG. 3 may be used to set up a wireless device for practicing the invention Such wireless devices include laptop computers with wireless capabilities, cellular telephones, wireless PDAs or the like, as discussed in conjunction with FIG. 2. The various embodiments may be implemented with a wired device capable of sending e-mails, for example, a desktop computer or laptop computer without wireless capabilities. An example of such non-wireless use would occur when a user takes their laptop computer to a meeting, uses the various embodiments to collect e-mail information of the meeting's attendees, and then returns to the user's office after the meeting to connect their laptop to a network and send e-mail messages. Other scenarios exist for using the various embodiments with an electronic device with the capability to send e-mail, albeit, without wireless capabilities. For example, some embodiments can be practiced using a laptop computer which can exchange e-mail address via RFID, and then later be connected to a network to send and receive e-mail. To facilitate the illustration of the invention, the various embodiments will be described herein in terms of being implemented on a wireless device, even though other implementations may be practiced.

The method begins at 301 and proceeds to 303 where the application software for implementing the invention in a wireless device is downloaded, or otherwise programmed into, the wireless device. The application software may be initially loaded onto the wireless device in the factory, purchased by the user from a brick-and-mortar store on floppy disks, downloaded from the Internet, or otherwise communicated to the wireless device. The application software may be in the form of a software product for communicating an e-mail address, and may be in the form of a computer readable program stored on an electronically readable medium (e.g., a compact disk, a DVD, a floppy disk, a dongle memory, a memory chip, or the like). Once the application software is downloaded onto the wireless device the method proceeds to 305 to detect the configuration of the wireless device. This may include detecting the type of operating system, the type of software used for e-mail capabilities, detecting the processor used in the wireless device and the amount and location of memory, detecting the communications formats, determining what user input/output components are available (e.g., touchpad, keyboard, mouse, display screen, speaker, or the like). Once the device configuration has been ascertained in 305 the method proceeds to 307.

In block 307 it is determined whether the user wants to customize the application software themselves, or install a default version of the configuration options. The default version may vary from one type of wireless device to another, so as to enhance the usefulness of a given set of capabilities on that particular wireless device, based on the device configuration detected in block 305. If, in 307 the user opts to customize the configuration, the method proceeds from 307 to 309 via the USER CONFIG branch. In 309 the user is presented with options for setting up the application. The options available to the user may include any type of features affecting the performance, operation or appearance of the RFID e-mail application program. Such features may include options for setting up the menuing system, for specifying the buttons to be used in controlling the program, for providing an input for the RFID reader and tag (if these components are not already integrated into the wireless device), and options for setting up the actual e-mail itself such as specifying a signature line, storing the e-mail in a draft section or leaving it open to be completed, or the like. Once the user has specified the options for the RFID e-mail application program in 309, the method proceeds to 311. Back in 307, if the user opts to go with the default configuration the method proceeds along the DEFAULT branch from 307 to 311.

In block 311 any drivers which may be needed are loaded. For example, if a driver is needed for the program to communicate with the RFID receiver or detector, the driver is loaded in 311. Once all drivers needed to run the application program have been loaded in 311 the method proceeds to 313. In 313 it is determined whether the particular e-mail program in use on the email device is compatible with the application program. That is, it is determined whether the application program of the RFID e-mail address autogenerator can operate in conjunction with the e-mail program to either save e-mail addresses which have been detected or use them to populate an e-mail. If the e-mail program is compatible the method proceeds from 313 along the “YES” branch to 317. If it is determined in 313 that the e-mail program is not compatible, the method proceeds from 313 along the “NO” branch to 315.

In 315 an output method is selected to communicate or otherwise provide any detected e-mail addresses to the e-mail program of the email device. The e-mail address data in the signal may be produced in a format acceptable to an e-mail application program, such as a vCard format or other like format. If the e-mail program will not permit the RFID e-mail address autogenerator application program to open an e-mail and populate it with detected e-mail addresses, the RFID e-mail application program may instead be configured to save the detected e-mail addresses to a file of a predefined format. In this way, the user could open the file from within the e-mail program and access the e-mail addresses.

Alternatively, the user could access the file and cut-and-paste the e-mail addresses into an e-mail being created. In another embodiment, the RFID e-mail application program could itself send an e-mail to the user containing the detected e-mail addresses, so that the user would readily be able to access them. Once the output method is selected in block 315 the method proceeds to 317.

In 317 the storage preferences are set up. Similar to the output method in 315, the RFID e-mail application program may be configured to store any detected e-mail addresses either within the e-mail program of the email device or in a different file, or both. In 317 the directory or other storage location is specified, as well as the formatting of the data (e.g., file format, time stamp, fields to be stored, or the like). Storage of the detected e-mail addresses may be done to provide access to the detected e-mail addresses, or for back up purposes. Once the data storage options have been specified the program proceeds to 319. In 319 the RFID e-mail application program controls and menuing scheme, and other options specifying the look-and-feel and performance of the program are set up. The method then proceeds to 321.

In 321 the RFID output preferences are set up. These preferences may include the e-mail address preferred by the user for communication via RFID, whether or not the user's name and/or additional contact information is to be included with the e-mail address, and any other variable concerning the content of the data to be delivered via RFID. In some embodiments the RFID signal may contain a URL where additional user information can be retrieved (e.g., email addresses, telephone numbers, other URLs, street address or the like). The RFID output preferences may also include the transmitter power level, in the event an active RFID transmitter is used, to set the transmission power level, any encryption scheme or encoding scheme used on the data, as well as the format for sending the data. Once the RFID output preferences have been specified in 321 the method proceeds to 323 to determine whether the setup is complete. If it is determined that the setup is not yet completed or the user want to change one or more values or parameters, the method proceeds from 323 via the “NO” branch back to 307. However, if it is determined in 323 that the setup is completed, the method proceeds along the “YES” branch to 325 where the method ends.

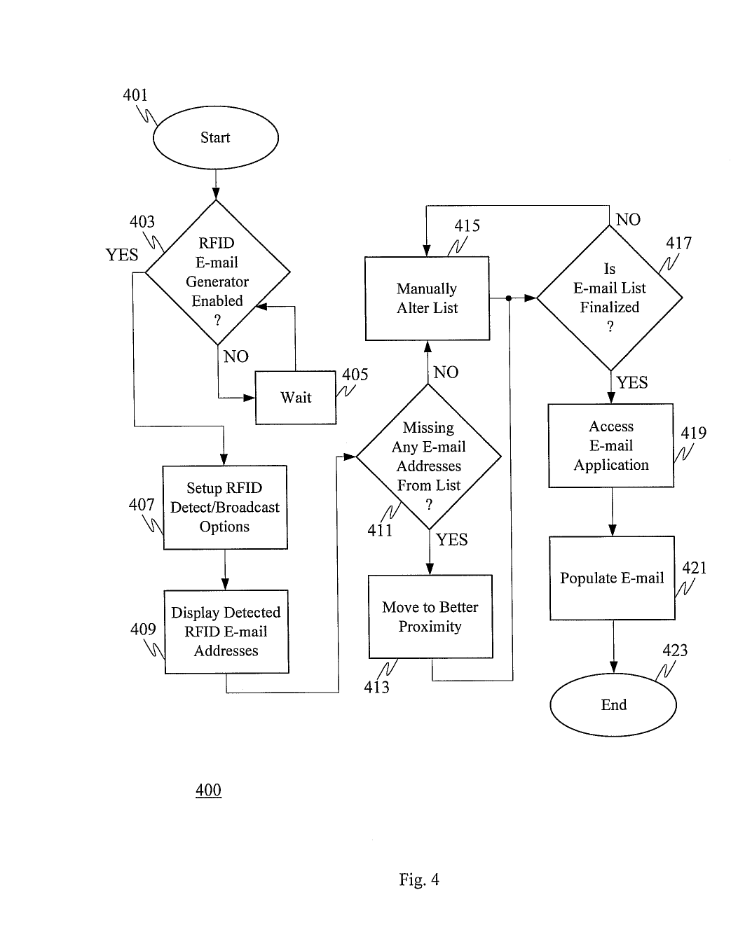

FIG. 4 depicts an exemplary method 400 of practicing various embodiments of the invention. The method begins at 401 and proceeds to 403 to determine whether the RFID e-mail generator is enabled. If it is determined that the RFID e-mail generator is not enabled the method proceeds to 405 to wait, and then loops back around to 403 again. If it is determined in 403 that the RFID e-mail generator is enabled the method proceeds from 403 along the “YES” branch to 407. Block 407 gives the user the opportunity to specify options for RFID detection and broadcast. For example, a user who does not want to give out their e-mail address at that time may choose to only receive RFID signals and not broadcast any signals. Or, in some instances, the user may have several different e-mail addresses. In 407 the user could specify which e-mail address to broadcast at that time. Any other parameters affecting the transmission and reception may be set in 407, including for example, the transmit power and/or the transmission mode or scheme if more than one are available for the email device. Once the options for RFID detection and broadcast have been specified in 407 the method proceeds to 409. In 409 the detected e-mail identities are displayed on the email device-that is, the e-mail addresses are displayed along with names associated with the e-mail addresses, if any, or other identities detected with RFID signals.

After displaying the detected e-mail identities in 409, the method proceeds to 411 where it is determined whether any e-mail identities are known to be missing from the list. For example, the user may look around the meeting and see that some of the people at the meeting do not have an e-mail address appearing on the list, or see that the number of attendees does not match the number of identities or e-mail addresses on the list. If it is determined that one or more identities is missing from the list, the method may proceed from 411 along the “YES” branch to 413. In 413 the user moves the email device to a better proximity for reception by either adjusting the position of device so the RFID antenna receives a stronger signal, or possibly by simply walking around the room or to a different location. Once the user has done this, the method proceeds to 417 to determine whether the list of detected identities is final.

Back in block 411, if it is determined that no e-mail identities are known to be missing from the list, the method proceeds from 411 along the “NO” branch to 415. In 415 the user is given the option to manually alter the list of e-mail identities. The user may remove any e-mail addresses from the list, if, for example, the user does not want to send an e-mail to that person, or an e-mail identity was detected for someone who was not actually participating in the meeting or otherwise does not belong on the list. The user may also be prompted by the email device to add more e-mail addresses to the list. This could occur, for example, if there are other people present whose e-mail identities were not detected by the user's email device, or the user simply wants to add more names to the e-mail mailing list. In either case, once the user is finished manually altering the list the method proceeds from 415 to 417.

In block 417 it is determined whether the list of e-mail identities is finalized. If the user decides the list is not finalized, the method proceeds from 417 along the “NO” branch to 415. In some instances the user may opt to move to a better proximity for reception as described in 413, rather than manually altering the list. If, in block 417, it is determined that the list of e-mail addresses is complete, the method proceeds from 417 along the “YES” path to 419 to access the e-mail application used on the user's email device, e.g., Lotus Notes, Microsoft Outlook, Eudora, Mozilla Thunderbird, Pegasus, Claris, Blitzmail, Pronto Mail, Mutt, Pine, or the like. In some embodiments, several or all of the functions outlined above for practicing the invention may be done either in the e-mail application program itself or with the RFID e-mail application program working in conjunction with the e-mail application. In some embodiments, rather than accessing or passing data directly to the e-mail application program, a data file associated with the e-mail application program is accessed and modified to include the detected e-mail addresses.

Once the e-mail application has been accessed the method proceeds to 421 to populate an e-mail message with the e-mail addresses that have been obtained using the RFID e-mail application program. Depending up the options chosen by the user, the RFID e-mail application program may set up an e-mail with the user's signature line, ready to content to be added by the user before mailing. For example, the e-mail addresses detected using RFID tags may be used to complete the “To:” field in the e-mail application program. Alternatively, the e-mail address can be stored within the e-mail application in a format conducive to retrieval by the user, for example, as an e-mail group, or in a “contact” folder. In general, the detected e-mail address may be saved in any format convenient to the user, as would be known by those of ordinary skill in the art. Once an e-mail message has been populated or the e-mail addresses have otherwise been saved in block 421, the method proceeds to 423 and ends.

Various steps may be included or excluded as described herein, or performed in a different order, with the rest of the activities still remaining within the scope of at least one exemplary embodiment. For example, a particular user may not be interested in seeing the detected e-mail address displayed and may not want the option of editing the list of detected e-mail addresses. In such instances the blocks 409-417 would be omitted and the method would proceed directly from 407 to 419. It is expected that those of ordinary skill in the art may perform would know to change the order of the activities in other manners as well.

The processing units, processors and controllers described herein (e.g., processor 103 of FIG. 1B) may be of any type capable of performing the stated functions and activities. For example, a processor may be embodied as a microprocessor, microcontroller, DSP, RISC processor, or any other type of processor that one of ordinary skill in the art would recognize as being capable of performing the functions described herein. A processing unit in accordance with at least one exemplary embodiment can operate computer software programs stored (embodied) on computer-readable medium, e.g. hard disk, CD, flash memory, ram, or other computer readable medium as recognized by one of ordinary skill in the art. The computer software programs can aid or perform the steps and activities described above. For example computer programs in accordance with at least one exemplary embodiment may include source code for performing the functions, activities, and/or steps described herein, and these are intended to lie within the scope of exemplary embodiments.

The use of the word “exemplary” in this disclosure is intended to mean that the embodiment or element so described serves as an example, instance, or illustration, and is not necessarily to be construed as preferred or advantageous over other embodiments or elements. The term “e-mail application,” as used herein, is intended to mean any software application or routine that sends an electronic e-mail message, for example, over the Internet, and/or is able to receive an e-mail response. The description of the invention provided herein is merely exemplary in nature, and thus, variations that do not depart from the gist of the invention are intended to be within the scope of the embodiments of the present invention. Such variations are not to be regarded as a departure from the spirit and scope of the present invention.

What is claimed is:

1. A method for communicating an e-mail address, the method comprising:
receiving an RFID signal that corresponds to the e-mail address; and
providing the e-mail address to the e-mail application program.

2. The method of claim 1, wherein the RFID signal is received at a device with e-mail capability, and wherein said providing the e-mail address further comprises providing the e-mail address in a predefined format to an e-mail application program.

3. The method of claim 2, further comprising:
sending an interrogation signal at a time of composing an email;
wherein the RFID signal is sent in response to the interrogation signal by a meeting participant.

4. The method of claim 2, wherein said providing the e-mail address comprises:
modifying a data file associated with the e-mail application program to include the e-mail address.

5. The method of claim 2, wherein said providing the e-mail address further comprises:
sending the e-mail address as content in an incoming e-mail.

6. The method of claim 2, wherein the e-mail application program is configured to create an outgoing e-mail addressed to the e-mail address.

7. The method of claim 1, wherein said e-mail address is a first e-mail address, the method further comprising:
displaying a list of all detected e-mail addresses, the list comprising said first e-mail address and at least one additional e-mail address.

8. The method of claim 7, further comprising:
accepting an input from a user to modify said list of all detected e-mail addresses.

9. The method of claim 1, wherein said contact information comprises a URL associated with a site which includes a vCard object including said e-mail address.

10. The method of claim 2, further comprising:
storing the email address within an address book of the e-mail application program, or other format configured for storage and retrieval of the email address.

11. An apparatus for communicating an e-mail address, the apparatus comprising:
an RFID receiver;
memory configured to store information from a received RFID signal, said information including contact information comprising the e-mail address;
computer logic configured to reformat the e-mail address into a format acceptable to an e-mail application program; and
computer logic configured to provide the e-mail address to the e-mail application program.

12. The apparatus of claim 11, wherein the apparatus is a device with wireless e-mail capability.

13. The apparatus of claim 12, further comprising:
an RFID device configured to transmit an interrogation signal;
wherein the received RFID signal is received in response to the interrogation signal.

14. The apparatus of claim 12, wherein the device includes an e-mail application program configured to create an outgoing e-mail addressed to the e-mail address.

15. The apparatus of claim 11, further comprising:
a display unit configured to show a list of all detected e-mail addresses, the list comprising said first e-mail address and at least one additional e-mail address.

16. The apparatus of claim 15, further comprising:
a keyboard configured to accept inputs from a user to modify said list of all detected e-mail addresses.

17. The apparatus of claim 16, wherein said inputs from the user are further configured to delete at least one of the e-mail addresses from the list, in response to the user input.

18. A software product comprising an electronically readable medium including a program of instructions, wherein the program of instructions upon being executed on a device causes the device to:
receive an RFID signal with contact information including an e-mail address;
reformat the e-mail address into a format acceptable to an e-mail application program; and
provide the e-mail address to the e-mail application program.

19. The software product of claim 18, further causing the device to:
send an interrogation signal;
wherein the RFID signal is received in response to the interrogation signal.

20. The software product of claim 18, further causing the device to:
display a list of all detected e-mail addresses, a list comprising a first e-mail address and at least one additional e-mail address.
